(19) United States
(12) Patent Application Publication
(10) Pub. No.: US 2008/0099343 A1
(43) Pub. Date: May 1, 2008

(54) Electrochemical machining method and apparatus

(76) Inventors: Thomas William Brew, Corning, NY (US); Nitin Das, Painted Post, NY (US)

Correspondence Address: CORNING INCORPORATED, SP-TI-3-1, CORNING, NY, 14831, US

(21) Appl. No.: 11/590,282

(22) Filed: Oct. 31, 2006

(51) Int. Cl. B23H 3/02

(52) U.S. Cl. 205/642

(57) ABSTRACT

An electrochemical machining system and method includes at least one tube arranged in a first fixture, a second fixture arranged adjacent to the first fixture, the second fixture adapted for supporting a workpiece relative to the tube, a translation mechanism which causes relative movement between the first fixture and the second fixture, a power supply which supplies a current to the workpiece and the tube, and a control unit which controls the power supply to alternately apply a forward current and a zero current (C₀) to the workpiece and the tube for a total time interval (tₜ) wherein deplation of the workpiece occurs and bubbles are separated from the tube. This may be followed by a reverse current (C_{R}) or voltage to the workpiece and the tube for a second time interval (t_{R}), wherein deplation of the workpiece occurs.

### FIELD OF THE INVENTION

The invention relates generally to an electrochemical machining method and apparatus. More particularly, the invention relates to an electrochemical machining method and apparatus for making holes in steel articles, such as feedholes in extrusion dies.

### BACKGROUND OF THE INVENTION

Extrusion dies for manufacturing ceramic honeycomb bodies, such as used for manufacturing catalytic converter substrates and diesel exhaust filters, may be manufactured by an electrochemical machining processes, such as described in U.S. Pat. Nos. 4,687,563; 5,322,599; 5,320,721; 5,507,925; and 5,997,720, for example. In a typical electrochemical machining process, a hollow conductive tube connected to a source of liquid electrolyte acts as a cathode, and the workpiece in which feedholes will be drilled acts as an anode. The hollow conductive tube is placed opposite the workpiece, and liquid electrolyte is pumped down the hollow tube's bore. The liquid electrolyte facilitates electrical conduction between the hollow tube and the workpiece. Application of electrical potential and current between the hollow tube and the workpiece across a relatively narrow gap causes deplation or etching of the workpiece, and material removal. Application of electrical energy continues until a feedhole of the desired diameter and length has been formed into the workpiece. As the feedhole is drilled, the metal dissociated from the workpiece is purged from the hole by the liquid electrolyte flowing between the hollow tube and the workpiece.

One electrochemical machining method according to the “prior art” is shown in FIG. 4. Typically, the method requires a generally constant forward current C_{A} from a constant current source to form the feedholes. From time to time, for example, after a time interval t_{A}, there may be current reversals of current C_{R} for short intervals to remove (deplate) any buildup of contaminants on the tip of the hollow tube due to metal deplation from the workpiece. Typically, this may be accomplished by reversing the polarity of a current source connected to the hollow conductive tube cathode, thereby causing a negative reverse current C_{R} for a time t_{R} as is shown in FIG. 4. However, such excursions to negative current do affect the service life of the tube because some of the tube may also be removed during the process. Accordingly, there is a need to minimize the frequency of occurrence of such reversals, if possible, while still adequately removing buildup on the cathode.

Furthermore, the electrochemical machining process may include a pulsed current, voltage, or feed rate as described in U.S. Pat. No. 5,997,720. This provides a variation in the surface finish and roughness in the thus formed feedholes. In one example, the drilling conditions were switched back and forth between two sets of drilling conditions. For example, a first set, as illustrated in FIG. 3, may include an constant applied current, C_{A}, of about 200 amperes, for example, applied for a first time interval, t_{A}, and a second lower applied constant current, C_{B}, of about 162 amperes, for example, applied for a second time interval, t_{B}.

However, in electrochemical machining, cathode wear is, and continues to be, an expensive and nagging problem. Accordingly, there continues to be a need for methods and apparatus for reducing the rate of wear of the hollow tube cathode.

### SUMMARY OF THE INVENTION

The applicants noticed that during the electrochemical machining process, frequently hydrogen bubbles evolve in the liquid electrolyte between the hollow tube cathode and the workpiece. The bubbles tend to adhere to the hollow tube cathode. These bubbles may undesirably reduce the conductivity of the liquid electrolyte. If these bubbles are not devolved and flushed out, it can result in severe wear of the hollow tube cathode, as well as error in obtaining the desired feedhole diameters. Such wear can have a deleterious effect on the quality and uniformity of the workpiece feedholes thus drilled. For example, where the workpiece is an extrusion die, severe wear of the hollow tube cathode can result in dimensional irregularities and variations in the extrusion die feedholes across the workpiece, which may appear as thickness irregularities in the honeycomb body extruded with the extrusion die due to uneven flow. Irregularities in the honeycomb body may, in turn, affect the performance, isostatic strength, and/or dimensional quality of the honeycomb body, and may cause uneven wear in the dies.

In view of the wear problems of the prior art electrochemical machining methods, a method and apparatus for devolving hydrogen bubbles from the hollow tube in an electrochemical machining process is provided. Further, in another aspect, a method for removing buildup of contaminants on the cathode tube is provided. Therefore, in one broad aspect, the invention is an electrochemical machining apparatus. The inventive apparatus comprises at least one tube (cathode) arranged in a first fixture, a second fixture in opposing relation to the first fixture, the second fixture adapted for supporting a workpiece (anode) in opposing relation to the tube, a translation mechanism which causes relative movement between the first fixture and the second fixture, a power supply which applies a voltage potential across the workpiece and the tube, and a control unit which controls the power supply such that the power supply alternately applies a forward current (or voltage potential) and a zero current (or voltage potential) across the workpiece and the tube for a first time interval. This may be combined with a reverse voltage potential across the workpiece and the tube for a second time interval. Deplation of the workpiece occurs during application of the forward current (or forward voltage potential). Frequent purging of the hydrogen bubbles by circuits back to substantially zero current( or substantially zero voltage potential) dramatically minimizes the need for the deplating (negative voltage or current) intervals and consequently reduces wear of the cathode tube.

According to further embodiments, the invention is directed to a method of drilling holes in a workpiece which comprises advancement of a tube (cathode) into the workpiece to form a hole in the workpiece. This advancement comprises alternately applying a forward current, C_{A} (or voltage potential) and a substantially zero current, C₀ (or voltage potential) across the workpiece and the tube for a first time interval. This may be combined with application of a reverse voltage potential (or current, C_{R}) across the workpiece and the tube for a second time interval, t_{R}.

Other features and advantages of the invention will be apparent from the following description and the appended claims.

### BRIEF DESCRIPTION OF THE DRAWINGS

The accompanying drawings, described below, illustrate various embodiments of the invention and are not to be considered limiting of the scope of the invention. The figures are not necessarily drawn to scale, and certain features and certain view of the figures may be shown exaggerated in scale or in schematic in the interest of clarity and conciseness.

FIGS. 1 and 2 illustrates a schematic diagram of an electrochemical machining apparatus according to the invention.

FIG. 3 illustrates a pulsed current profile for an electrochemical machining process according to the “Prior Art.”

FIG. 4 illustrates a constant current profile with current reversals for the electrochemical machining process according to the “Prior Art.”

FIG. 5 illustrates a current/voltage profile for the electrochemical machining process according to a first embodiment of the invention.

FIG. 6 illustrates a current/voltage profile for the electrochemical machining process according to a second embodiment of the invention.

FIG. 7 illustrates a current/voltage profile for the electrochemical machining process according to a third embodiment of the invention.

FIG. 8 illustrates a current/voltage profile for the electrochemical machining process according to a fourth embodiment of the invention.

FIG. 9 illustrates a current/voltage profile for the electrochemical machining process according to a fifth embodiment of the invention.

### DETAILED DESCRIPTION OF THE INVENTION

The invention will now be described in detail with reference to a few preferred embodiments, as illustrated in the accompanying drawings. In describing the preferred embodiments, numerous specific details are set forth in order to provide a thorough description and understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

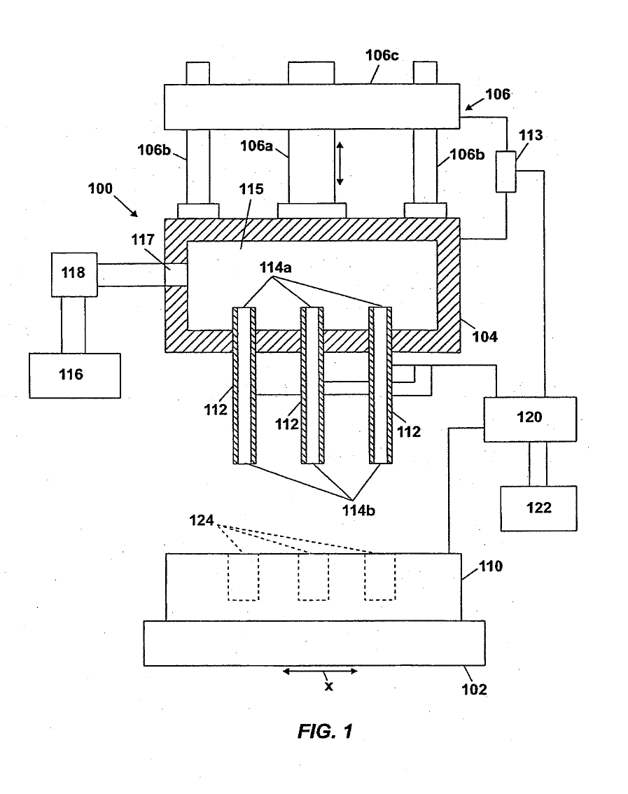

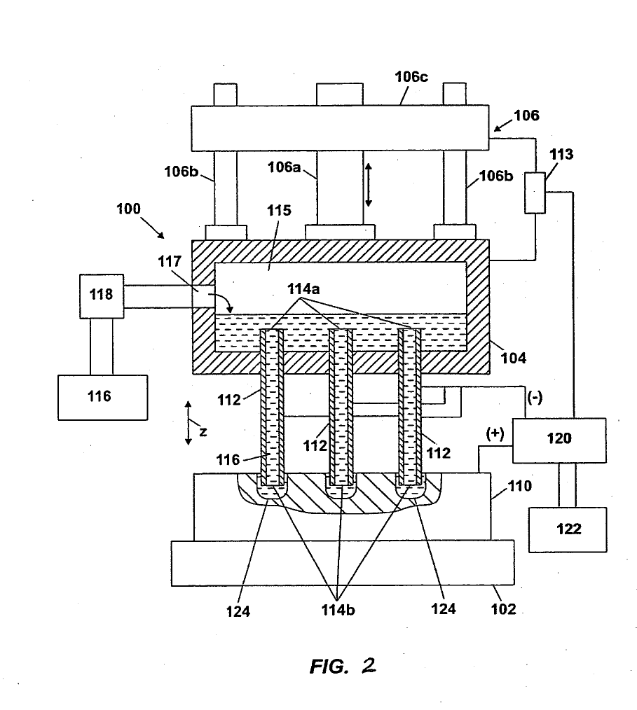

FIGS. 1 and 2 illustrate a simplified diagram of an electrochemical drilling system 100 of the invention. The system 100 includes a lower fixture 102 and an upper fixture 104 arranged in opposing relation thereto. The lower fixture 102 holds and supports a workpiece 110, such as a blank of hard, preferably metal material for forming an extrusion die. The upper fixture 104 holds and supports one or more hollow tubes 112; preferably multiple tubes aligned in rows, and more preferably arranged and aligned in multiple rows. The hollow tubes 112 may be held in the upper fixture 104 using any suitable means. For example, the hollow tubes 112 could be inserted in apertures in the upper fixture 104 and fixed thereto by any suitable means, e.g., clamping, fasteners, welds or threading. Optionally, the lower fixture 102 may incorporate a translation stage to allow for flexibility in positioning the workpiece 110 relative to the hollow tubes 112. For example, an X-Y table may be employed allowing the workpiece 110 to be repositioned (see, for example, arrow labeled X) as desired in the X or Y (perpendicular to X) directions. The inlet ends 114a of the hollow tubes 112 are coupled to a source of liquid electrolyte 116. For example, the inlet ends 114a may open into a chamber 115 in the upper fixture 104 which can receive liquid electrolyte 116 through port 117 in the upper fixture 104. The liquid electrolyte 116 may be an acidic solution, such as nitric acid, hydrochloric, sulfuric, or combinations. The liquid electrolyte 116 is preferably diluted, preferably exhibiting a volumetric acid concentration of about 16-18%. A pump 118 or other suitable flow-inducing device may be used to provide a flow of the liquid electrolyte 116 into the chamber 115 in the upper fixture 104.

The hollow tubes 112 are positioned for drilling holes 124 such as feedholes (indicated by dotted outlines) in the workpiece 110. The drilling occurs due to deplation or etching of material from the workpiece 110. The hollow tubes 112 are made of a conductive material, typically a metal or an alloy. The material of the hollow tubes 112 may or may not be the same as the material of the workpiece 110 and need not be as hard as the material of the workpiece 110. For machining of die blanks, preferably the tubes are manufactured from any suitable electrically conductive material, such as a metal, the sides of which are coated with a dielectric material to confine machining to the end of the tube 112. The workpiece 110 is also made of a conductive material, typically a metal or an alloy. The material for the workpiece 110 may be selected based on the intended application of the drilled workpiece. For example, for a workpiece 110 that is a blank for a honeycomb extrusion die, the workpiece 110 may be made of hard conductive materials, such as steel. Most preferably, the material may be a stainless steel material, such as 321 or 414 stainless steel, Inconel® 625, 718, X-750, or 825 or such as 17-4 PH, for example. FIG. 2 shows holes 124 being formed in the workpiece 110. The spacing between the hollow tubes 112 determine the spacing between the holes formed in the workpiece 110. Liquid electrolyte 116 pumped down the hollow tubes 112 from the inlets 114a during drilling of the holes 124 exit the outlet ends 114b of the hollow tubes 112 and flows into the holes 124, thereby allowing electrical conduction between the hollow tube 112 and the workpiece 110 without the hollow tube 112 making physical contact with the workpiece 110. The electrolyte fluid 116 also flushes deplated debris from the holes 124.

The upper fixture 104 is movable relative to the lower fixture 102 so that the hollow tubes 112 can advance (in the Z direction) into the workpiece 110 as the holes 124 are drilled. In one example, a translation mechanism 106 is coupled to the upper fixture 104 and moves the upper fixture 104 relative to the lower fixture 102 in the Z direction. Any suitable translation mechanism may be used, provided the translation mechanism allows the upper fixture 104 to move relative to the lower fixture 102 in at least the vertical direction. For example, the translation mechanism 106 may include a linear actuator 106a, such as a lead screw actuator or pneumatic or hydraulic cylinder, coupled to the upper fixture 104. The translation mechanism 106 may further include a crosshead 106c which supports the linear actuator 106a. The translation mechanism 106 may further include guide rods 106b coupled to the upper fixture 104. The guide rods 106b may act to prevent the upper fixture 104 from wobbling as it is moved relative to the lower fixture 102 by the linear actuator 106a. Additional movement capability may be employed by adding a X-Y motion to the translation mechanism 106, thereby eliminating the need for the X-Y table to move the workpiece 110. Any suitable mechanism for moving the tubes 112 relative to the workpiece 110 may be used.

The system 100, as best shown in FIGS. 1 and 2, includes a power supply 120, which is used to apply a current to the hollow tubes 112 and voltage potential across the workpiece 110 and the hollow tubes 112. The system 100 further preferably includes a control unit 122 which determines the amount of current applied to the hollow tubes 112, whether the current is in the forward direction or reverse direction, and for what duration the current is applied. When current is applied in the forward direction, the workpiece 110 acts as an anode and the hollow tubes 112 act as cathodes. When the current is applied in the reverse direction (by switching polarity of the power unit), the workpiece 110 acts as a cathode and the hollow tubes 112 act as anodes. The workpiece 110 is deplated or etched to form holes 124 when a forward current is applied across the workpiece 110 and hollow tubes 112. Reversing the current applied across the workpiece 110 and hollow tubes 112 removes contaminant buildup from the hollow tubes. A position sensor 113 may be coupled to the upper fixture 104 or the translation mechanism 106 to monitor the vertical distance between the upper fixture 104 and the lower fixture 102 while the holes 124 are formed. This vertical distance may be used to determine when the holes 124 have reached a desired depth, at which point the electrochemical drilling may stop.

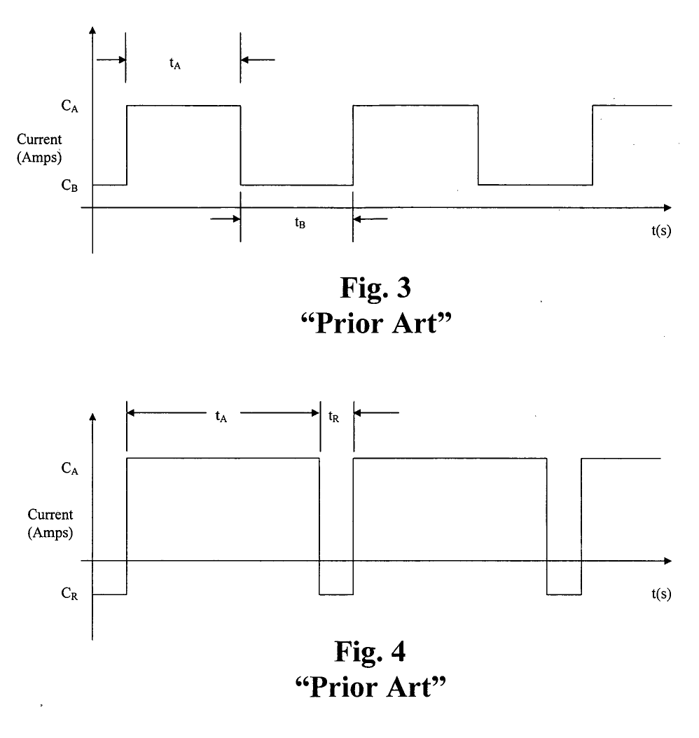

Referring now to FIG. 3, in one example according to the “Prior Art,” the configuration of the control unit is such that a forward constant current (C_{A}) is applied for a time t_{A}. This is followed by a lower applied constant current (C_{B}) applied for a time t_{B}. This allows surface variations and a desired level of surface roughness to be formed in the sidewalls of the holes thus formed.

Referring now to FIG. 4, in another example according to the “Prior Art,” the operation of the control unit is such that a constant forward current (C_{A}) is applied for a time interval t_{A}. This is followed by a polarity reversal and application of a reverse current (C_{R}) for a time interval t_{R}. This allows the deposits or buildup on the hollow tubes to be deplated. The reversal is for a time of between 0.05 to 3.0 sec. after 0.1 to 30 sec. of forward operation.

Now referring to FIG. 5, the present invention method and apparatus is described with reference to a first embodiment of the invention. In this embodiment, the power source is first controlled such that in a forward portion of the cycle, a forward current (C_{A}) is applied for a first time interval (t_{A}). During this forward cycle, material is removed (deplated) from the workpiece. Next, a substantially zero current (C₀) is applied to the hollow tubes (112 in FIGS. 1 and 2) for a second time interval (t₀). The total time interval (tₜ) is given by the relationship: (tₜ)=(t_{A})+(t₀). This current wave form may be repeated, over and over, at any suitable frequency. It has been discovered that having intervals where the current steps back to substantially zero allows the hydrogen bubbles formed during the process to devolve or separate from the cathode tube. After a defined number of cycles including the combination of forward portions and substantially zero current portions, a reverse voltage (V_{R}) or reverse current (C_{R}) is applied to the workpiece 110 and the hollow tubes 112 for a reverse time interval (t_{R}). The reverse voltage is preferred to be a value of about less than 1 volt, or even less than 0.5 volt, or between about 0.05 and 0.2 volt. It has been found to be desirable that the first time interval (t_{A}) may be longer than the second time interval (t₀). For example, the time interval (t_{A}) may be about 25 timers or more longer than the time the interval (t₀). Interval (t_{A}) may be between about 1 and 50 seconds, or even 5-20 seconds, whereas the second time interval (t₀) may be between 0.01 seconds and 1 minute, or even 0.05 seconds to 0.5 seconds. Again, this repetition of the pattern of forward portions and substantially zero portions may be repeated until holes having a desired depth have been drilled in the workpiece 110.

As was recognized by the inventors herein, utilization of the substantially zero portions allows the traverses to reverse voltage V_{R} or current C_{R} to be provided at a significantly lesser frequency than when not employed. Advantageously, applying the reverse voltage or current intervals at a reduced frequency as compared to the forward cycle has the effect of prolonging the life of the hollow cathode tubes 112. According to embodiments of the invention, the traverses to reverse occur at a frequency much less than the traverses to substantially zero. For example, the negative reversals occur at a frequency of 1/50^{th} or less, or even 1/100^{th} or less than the frequency of the zero traversals.

The duration (t_{R}) of the traverses to reverse voltage (V_{R}) or current (C_{R}) should be only be so long that only the contamination buildup is removed from the hollow tubes 112 without any substantial deplating of the tube. Typical durations (t_{R}) are between about 0.01 seconds and 0.2 seconds. Particularly, the duration of the reversals (t_{R}) is significantly less than the duration of the forward current (t_{A}). The duration of the reversals (t_{R}) may be approximately equal to the duration (t₀) of the zero intervals.

Application of zero current (C₀) during the cycle corresponds to an idle time in the electrochemical machining process where material is not being etched from the workpiece 110. During this idle time, the hydrogen bubbles which have evolved during application of the forward current (C_{A}) have an opportunity to separate from the cathode tube and escape and be flushed from the holes in the workpiece 110, thereby allowing the appropriate level of conductivity to be maintained between the workpiece 110 and the hollow tubes 112. Allowing the bubbles to be separated and escape advantageously maintains a more constant conductivity and, thus, fosters the ability to more precisely control the applied current and voltage. This, of course, results in more precision machining and, thus, more uniform hole dimensions. As discovered by the inventors, adding this idle time dramatically reduces the required number of reversals and, thus, greatly reduces wear of the cathode tubes. Accordingly, more dies may be produced without changing out the tubes.

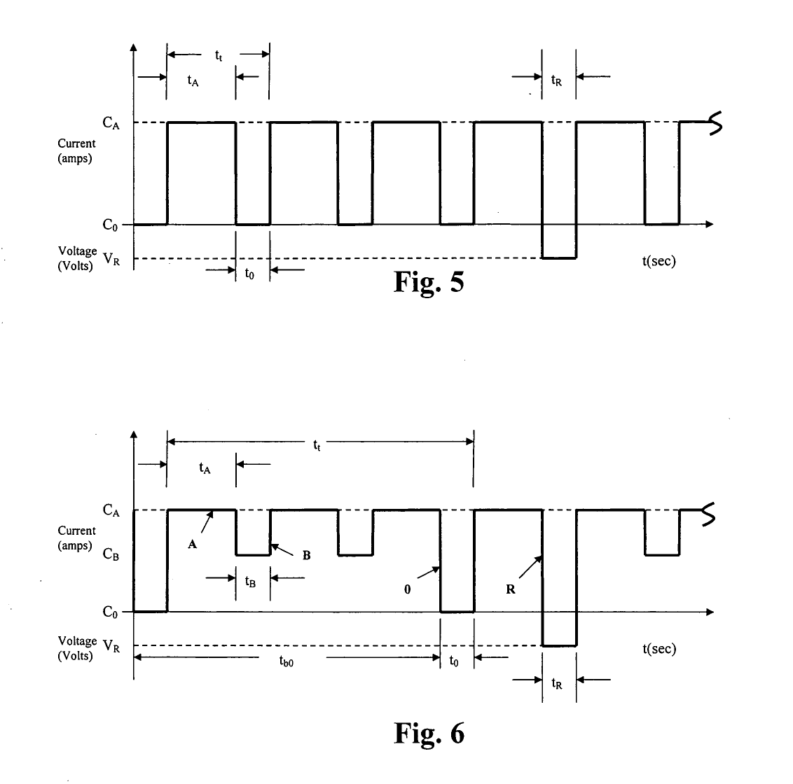

In another embodiment of the invention as best shown in FIG. 6, a representative waveform is shown. In this embodiment, rather than applying a single level of constant forward current, as in the FIG. 5 embodiment, a current is applied which includes alternating between a first higher constant current value (C_{A}) and a second lower constant current value (C_{B}). This forward cycle includes a first current (C_{A}) for a time interval t_{A}, and a lower forward current (C_{B}) for a time interval (t_{B}), followed by the substantially zero current (C₀) for a time interval (t₀). The total interval time (tₜ) for the forward plus substantially zero current interval is (tₜ). Duration (t₀) may be less than 1/50^{th} of duration (tₜ), and in some embodiments, even less than 1/100^{th}. Following a certain number of cycles to substantially zero current, say greater than 50 cycles or more, or even 100 cycles or more, a reversal may be applied, such as through a polarity change, to deplate material from the electrode tube which has been plated thereon during the ECM drilling. The reversal interval (t_{R}) may be about 0.01 to 1 seconds, for example. Application of the multiple levels of constant current (C_{A}) and (C_{B}) allows a feedhole to be drilled which has a periodically changing surface finish. For example interval (t_{A}) may be made to be substantially equal to (t_{B}) such that a surface pattern emerges with regions of wider and narrower hole dimensions along the length of the feedhole. Optionally, interval (t_{A}) may be made to be unequal to interval (t_{B}) thereby producing a different periodic pattern.

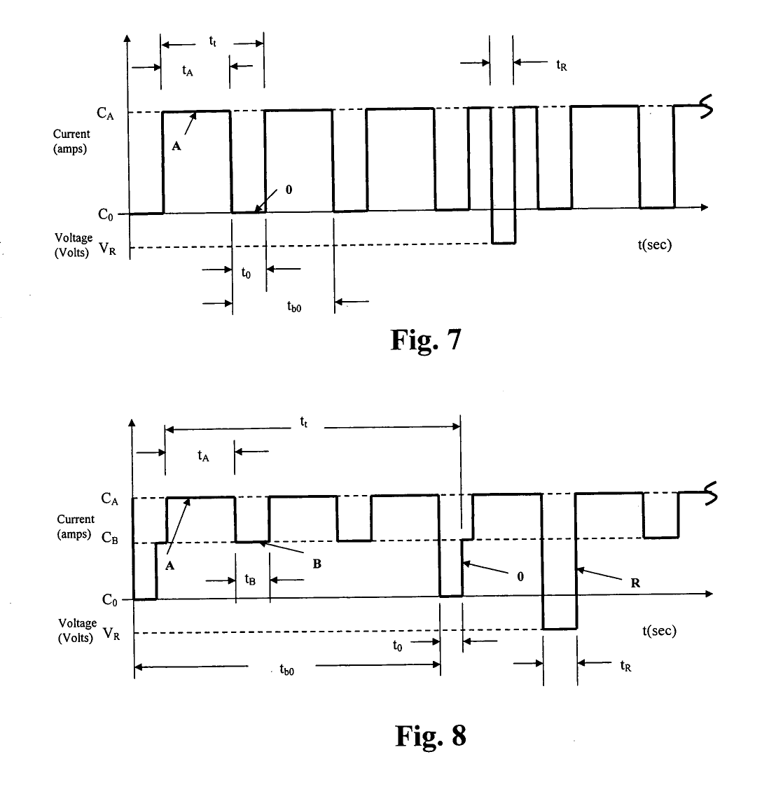

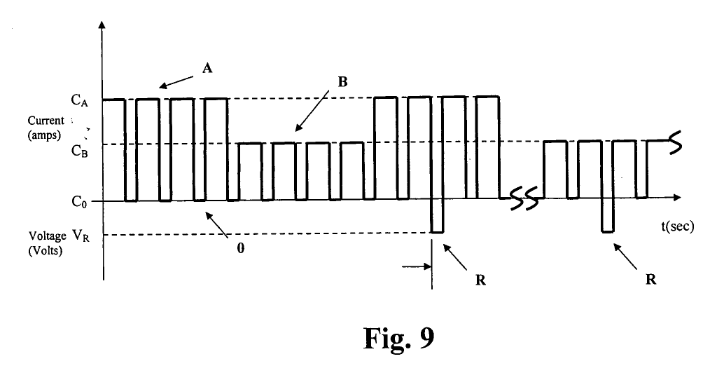

FIGS. 7 and 8 show embodiments illustrating that the reversals may be employed at any time during the forward current cycle. For example, the reversal may occur, and interrupt, in the middle an interval of forward current, and may be less than the duration t_{A}, or even less than the duration t₀. Likewise, it should be understood that the substantially zero interval t₀ may occur at the start of each forward interval, at the end of each forward interval, or in the middle of the interval (as shown in FIG. 8). The substantially zero current interval may even occur coincident with, and interrupt, either the higher C_{A} or lower C_{B} current interval. Optionally, as shown in FIG. 9, multiple substantially zero intervals may be included in each forward interval portion, A and B. For example, two or more zero intervals may occur for each forward interval A. Likewise, two or more zero intervals may occur for each forward interval B. Reversal, intervals may be included after multiple zero intervals, and even multiple forward cycles have occurred. For example, two or more forward intervals may occur for each reversal interval, or even greater than 10 forward intervals. The feed rate for the forward cycles portions A and B may be the same or different. In some embodiments, the feed rate and duration for each of portions A and B are designed such that the same distance is machined for each segment (See Ex. 3 in Table 1 below).

The appropriate levels and time intervals of forward, idle (zero) and reverse currents to apply are determined experimentally based on the material of the workpiece 110 and the desired surface condition. In several specific examples relating to drilling of a workpiece, such as a steel blank workpiece for an extrusion die, the following parameters were used:

TABLE 1
Experimental Current, Voltage and Time Interval Values

| | C_{A} | C_{B} | C₀ | V_{R} | t_{A} | t_{B} | t₀ | t_{b0} | t_{R} | | FR_{A} | FR_{B} |
|---|---|---|---|---|---|---|---|---|---|---|---|---|
| Ex. # | (Amps) | (Amps) | (Amps) | (Volts) | (sec) | (sec) | (sec) | (sec) | (sec) | Int | (in/sec.) | (in/sec.) |
| 1 | 136 | 127 | 0.0 | 0.1 | 18 | 18 | 0.1 | 5 | 0.1 | 150 | 0.025 | 0.025 |
| 2 | 138 | 158 | 0.0 | 0.1 | 16 | 9 | 0.1 | 10 | 0.1 | 100 | 0.044 | 0.025 |
| 3 | 374 | 411 | 0.0 | 0.1 | 16 | 9 | 0.1 | 5 | 0.1 | 60 | 0.054 | 0.028 |

It should be noted that these examples are provided for illustration purposes and should not be construed as limiting the invention as otherwise described herein. In the table, (C_{A}) and (C_{B}) are the applied currents for the forward segments A and B. respectively, as shown in FIGS. 6, 8, and 9, for example. (C₀) is the applied current for the substantially zero segment 0, as shown in FIGS. 6, 8, and 9, for example. (V_{R}) is the applied voltage for the substantially reversal segment R as shown in FIGS. 6, 8, and 9, for example. (t_{A}) and (t_{B}) are the time intervals for the forward current segments A and B, respectively, as shown in FIGS. 6, 8, and 9, for example. (t₀) and (t_{R}) are the time intervals for the substantially zero segment 0 and the reversal segments R, respectively, as shown in FIGS. 6, 8, and 9, for example. (t_{b0}) is the time interval between successive substantially zero segments 0, as shown in FIGS. 6, 8, and 9, for example. (Int) is the ratio of the number of traverses to substantially zero current (C₀) to the number of reversals to negative voltage (V_{R}), as follows:

Int=# traversals to zero/# reversals.

FR is the feed rate for intervals A and B, respectively.

The invention typically provides the following advantages. The electrochemical machining process of the invention allows uniform holes to be effectively drilled in a workpiece. According to the method of the invention, hydrogen bubbles, which can result in decreased conductivity, are flushed out and separated from the cathode tube more frequently by applying idle time (substantially zero current) from time to time. Further, when idle time is employed, reverse voltage intervals may be applied less frequently, e.g., after a predetermined number of sequential applications of forward and substantially zero current intervals, to remove plated buildup on the hollow tube. Preferably, the frequency of occurrence of the substantially zero traversals is greater than the occurrence reversal intervals. This has the effect of extending the life of the hollow tube.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An electrochemical machining apparatus, comprising:
at least one tube arranged in a first fixture;
a second fixture arranged adjacent to the first fixture, the second fixture adapted for supporting a workpiece relative to the tube;
a translation mechanism to cause relative movement between the first fixture and the second fixture;
a power supply which applies a current to the tube and the workpiece; and
a control unit which controls the power supply to alternately apply a forward current and a substantially zero current (C₀) for a total time interval (tₜ) wherein deplation of the workpiece and separation of bubbles from the at least one tube occurs.

2. The electrochemical machining apparatus of claim 1 further comprising applying a reverse voltage (V_{R}) for a time interval (t_{R}) wherein buildup removal from the tube occurs.

3. The electrochemical machining apparatus of claim 1 wherein the tube is hollow and serves as a conduit for an electrolyte liquid.

4. The electrochemical machining apparatus of claim 1, further comprising a source of an acidic electrolyte.

5. The electrochemical machining apparatus of claim 1; further comprising a sensor for monitoring a parameter related to the depth of a hole formed in the workpiece by the hollow tube.

6. The electrochemical machining apparatus of claim 1 wherein the total time interval (tₜ) is longer than the reverse time interval (t_{R}).

7. The electrochemical machining apparatus of claim 1 wherein a duration (t_{A}) in which the forward current (C_{A}) is applied is longer than the duration (t₀) in which the zero voltage potential (V₀) is applied.

8. The electrochemical machining apparatus of claim 1 wherein the forward current consists of a constant current (C_{A}).

9. The electrochemical machining apparatus of claim 1 wherein the forward current includes a first constant current (C_{A}) followed by a second constant current (C_{B}).

10. The electrochemical machining apparatus of claim 1 wherein a duration (t_{A}) in which the forward current is applied is longer than the duration (t₀) in which the substantially zero current (C₀) is applied.

11. The electrochemical machining apparatus of claim 1 wherein a ratio of the number of substantially zero current intervals to the number of reverse voltage intervals applied is greater than 50.

12. A method of electrochemically manufacturing holes by advancing a tube into a workpiece, comprising the steps of:
alternately applying a forward current and a substantially zero current (C₀) to the workpiece and the tube for a total time interval (tₜ) thereby deplating of the workpiece and causing bubbles to separate from the tube.

13. The method of claim 12 further comprising a step of applying a reverse voltage (V_{R}) to the workpiece and the tube for a reverse time interval (t_{R}), wherein buildup is deplated from the tube.

14. The method of claim 12 wherein the total time interval (tₜ) is longer than the reverse time interval (t_{R}).

15. The method of claim 12 wherein the forward current consists of a constant current (C_{A}).

16. The method of claim 12 wherein the forward current includes a first constant current (C_{A}) followed by a second relatively lower constant current (C_{B}).

17. The method of claim 16, wherein the first constant current (C_{A}) is applied for a time interval (t_{A}) and the second relatively lower constant current (C_{B}) is applied for a second interval (t_{B}) wherein interval (t_{A}) is substantially equal to interval (t_{B}).

18. The method of claim 12, further comprising repeating alternately applying the forward current and the substantially zero current (C₀) and applying a reverse voltage (V_{R}) until the hole reaches a desired depth.

19. The method of claim 12 wherein the workpiece is a blank for a honeycomb extrusion die.
